(19) United States
(12) Patent Application Publication
(10) Pub. No.: US 2015/0156539 A1
(43) Pub. Date: Jun. 4, 2015

(54) ELECTRONIC APPARATUS AND METHOD OF CONTROLLING AN ELECTRONIC APPARATUS

(71) Applicant: Kabushiki Kaisha Toshiba, Tokyo (JP)

(72) Inventor: Masahiro Takayama, Tokyo (JP)

(21) Appl. No.: 14/535,052

(22) Filed: Nov. 6, 2014

(30) Foreign Application Priority Data
Nov. 29, 2013 (JP) 2013-248154

(51) Int. Cl. H04N 21/438; H04N 21/41; H04N 21/435; H04N 21/858

(52) U.S. Cl. CPC H04N 21/4382; H04N 21/8586; H04N 21/4126; H04N 21/435

(57) ABSTRACT

According to one embodiment, an electronic apparatus includes a demodulator, an extraction processor, and a transmission processor. The demodulator generates first information by demodulating a tuned broadcast wave. The extraction processor extracts second information for an external apparatus, the second information comprising access information to another electronic apparatus, based on the first information. The transmission processor transmits data comprising the second information to a near-field communicator.

### CROSS-REFERENCE TO RELATED APPLICATIONS

This application is based upon and claims the benefit of priority from Japanese Patent Application No. 2013-248154, filed Nov. 29, 2013, the entire contents of which are incorporated herein by reference.

### FIELD

Embodiments described herein relate generally to an electronic apparatus comprising a tuner and a method of controlling the same.

### BACKGROUND

A service of displaying a QR code (registered trademark) during data broadcasting while a television is being watched and guiding a viewer to a web site of each broadcasting station is available.

The displayed QR code must be captured by a camera of an external apparatus (a smartphone, a tablet computer, etc.) and the captured QR code needs to be converted to a uniform resource locator (URL) by means of an application. Depending on the performance of the camera and application (noise reduction, recognition rate, etc.), the QR code may be captured a number of times.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing a system configuration of one of the embodiments.

FIG. 2 is an exemplary block diagram showing respective structures of a television, a remote controller and a smartphone.

FIG. 3 is an exemplary block diagram showing a structure of a data broadcasting application.

FIG. 4 is an exemplary flowchart showing steps of extracting a URL or a telephone number and transmitting the extracted URL or telephone number to the remote controller.

### DETAILED DESCRIPTION

Various embodiments will be described hereinafter with reference to the accompanying drawings.

In general, according to one embodiment, an electronic apparatus includes a demodulator, an extraction processor, and a transmission processor. The demodulator is configured to generate first information by demodulating a tuned broadcast wave. The extraction processor is configured to extract second information for an external apparatus, the second information comprising access information to another electronic apparatus, based on the first information. The transmission processor is configured to transmit data comprising the second information to a near-field communicator.

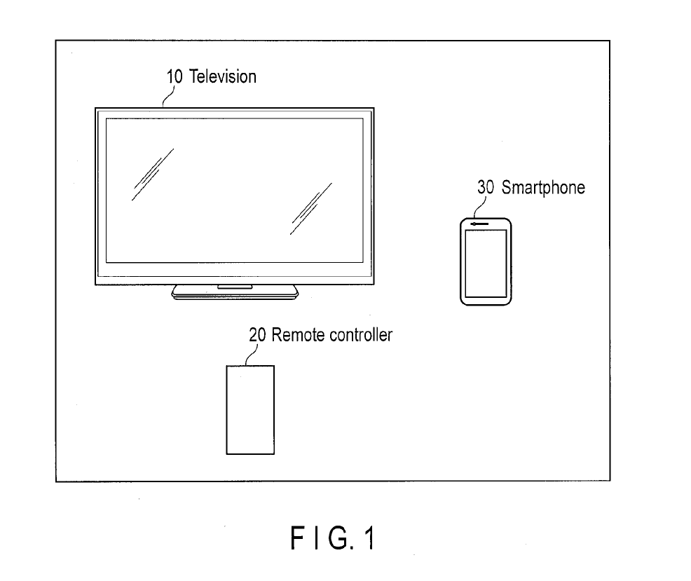

FIG. 1 is an illustration showing a system configuration of one of the embodiments.

As shown in FIG. 1, the system comprises a television (electronic apparatus) 10, a remote controller 20, a smartphone (mobile terminal) 30, etc.

The television 10 and the remote controller 20 can communicate with each other by, for example, Bluetooth (registered trademark). The television 10 can be operated by transmitting data from the remote controller 20 to the television 10. Furthermore, data can be transmitted from the remote controller 20 to the smartphone 30 by near-field communication (NFC). By transmitting data from the television 10 to the remote controller 20, the smartphone 30 can read data based on the data transmitted from the television 10 to the remote controller 20, from the remote controller 20, when an NFC receiving device of the smartphone 30 is brought near an NFC transmitting device of the remote controller 20.

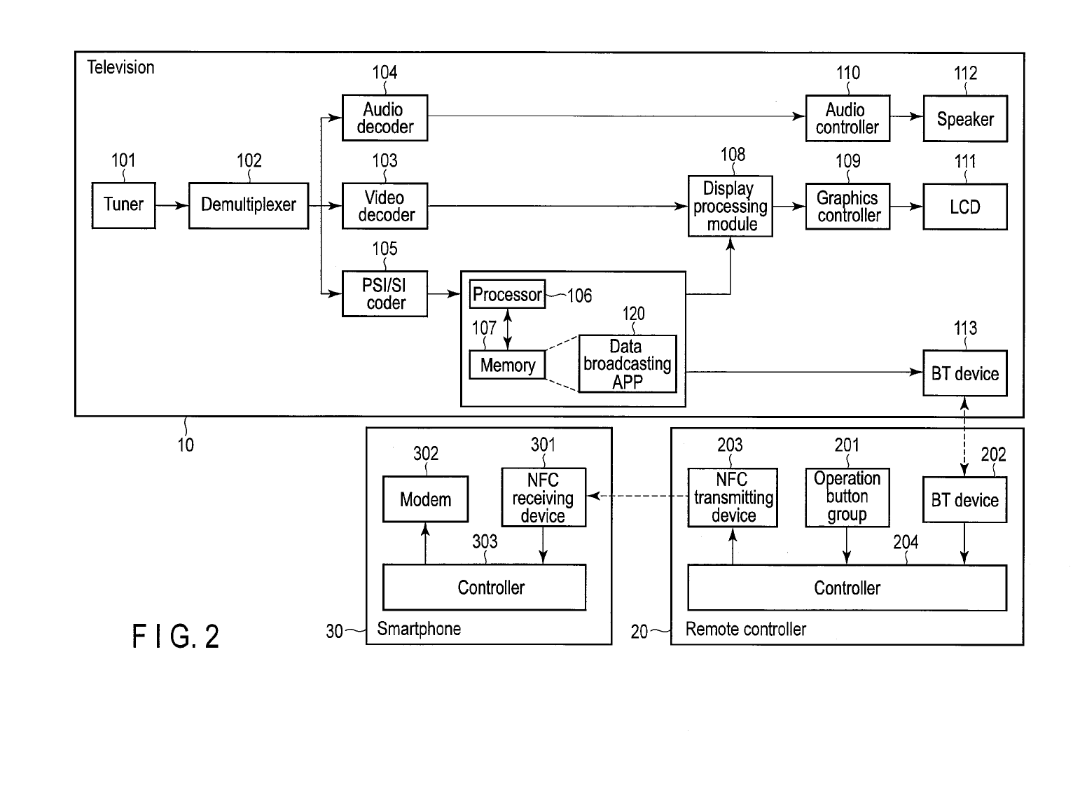

FIG. 2 is a block diagram showing respective structures of the television 10, the remote controller 20 and the smartphone 30.

The television 10 comprises a tuner 101, a demultiplexer 102, a video decoder 103, an audio decoder 104, a PSI/SI decoder 105, a processor 106, a memory 107, a display processing module 108, a graphics controller 109, an audio controller 110, a liquid-crystal display (LCD) 111, a speaker 112, a TV Bluetooth (registered trademark) device (BT device) 113, etc.

The tuner 101 tunes a broadcast wave selected from signals input from an antenna, demodulates the tuned broadcast wave and outputs a transport stream (TS) packet including video data, audio data and data for data broadcasting.

The demultiplexer 102 separates the TS packet (first information) output from the tuner 101 into video data, audio data and program specific information/service information (PSI/SI) data. The demultiplexer 102 outputs the separated video data to the video decoder 103, outputs the separated audio data to the audio decoder 104 and outputs the separated PSI/SI data to the PSI/SI decoder 105.

The video decoder 103 decodes the video data. The audio decoder 104 decodes the audio data. The decoded audio data is output to the speaker 112 by the audio controller 110.

The PSI/SI decoder 105 decodes the PSI/SI data and outputs the decoded data to the processor 106. The processor 106 executes a data broadcasting application (data broadcast APP) 120 loaded in the memory 107.

The data broadcasting application 120 has a function of generating data for displaying a display screen for data broadcasting based on data included in the PSI/SI data. The data broadcasting application 120 has a function of extracting second information such as a URL (address) of a website, a telephone number, etc., from the data for displaying data broadcasting included in the PSI/SI data, and of transmitting data for setting the extracted second information in an NFC transmitting device 203 provided in the remote controller 20 to the remote controller 20 by using the TV Bluetooth device 113.

The display processing module 108 executes processing for generating data for displaying an image on the LCD 111 from the decoded video data and the data for displaying a display screen for data broadcasting. The graphics controller 109 generates a video signal for displaying an image on the LCD 111 based on the generated data, and outputs the generated video signal to the LCD 111

The TV Bluetooth device 113 transmits data to the remote controller 20 in accordance with instructions from the data broadcasting application 120 and receives data transmitted from the remote controller 20.

The remote controller 20 comprises an operation button group 201, an RC Bluetooth device (BT device) 202, the NFC transmitting device 203, a controller 204, etc. The operation button group 201 comprises a plurality of buttons for operating the television 10. If a button in the operation button group 201 is operated, the controller 204 transmits data corresponding to the operated button to the television 10 by the RC Bluetooth device 202. The RC Bluetooth device 202 receives the data transmitted from the television 10. If the RC Bluetooth device 202 receives the data to be set in the NFC transmitting device 203, the controller 204 sets data based on the setting data in the NFC transmitting device 203.

The smartphone 30 comprises an NFC receiving device 301, a modem 302, a controller 303, etc.

The NFC receiving device 301 executes near-field communication with the NFC transmission device 203. The modem 302 transmits and receives packets and audio data by wireless communication. The controller 303 controls operations of the smartphone 30.

If the NFC receiving device 301 of the smartphone 30 is brought near the NFC transmitting device 203 of the remote controller 20, the NFC transmitting device 203 transmits the set data to the NFC receiving device 301.

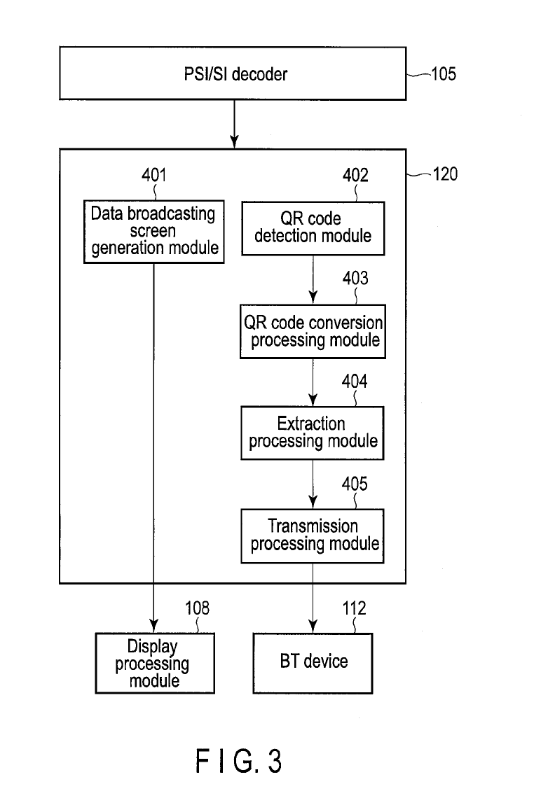

FIG. 3 is a block diagram showing a structure of the data broadcasting application 120.

The data broadcasting application 120 comprises a data broadcasting screen generation module 401, a QR code detection module 402, a QR code conversion processing module 403, an extraction processing module 404, a transmission processing module 405, etc.

The data broadcasting screen generation module 401 generates data for displaying a display screen for data broadcasting, based on the data included in the decoded PSI/SI data.

The QR code detection module 402 attempts to detect an image including a QR code (registered trademark) from image data included in the decoded PSI/SI data. If an image including a QR code is detected, the QR code detection module 402 transmits the image including the QR code to the QR code conversion processing module 403. The QR code conversion processing module 403 converts the QR code into a character string (third information). The QR code conversion processing module 403 delivers the character string to the extraction processing module 404.

The extraction processing module 404 extracts a character string (URL) beginning with “http” and ending with a domain such as “co.jp”, “.com”, etc., from text data included in the data or the data delivered from the QR code conversion processing module 403. The extraction processing module 404 extracts a number string of a digit number corresponding to a telephone number from text data included in the decoded PSI/SI data or the data delivered from the QR code conversion processing module 403. The extraction processing module 404 delivers the extracted character string or number string to the transmission processing module 405.

The transmission processing module 405 transmits data for requesting setting of the extracted character string or number string in the NFC transmission device 203, to the remote controller 20 by the TV Bluetooth device 113.

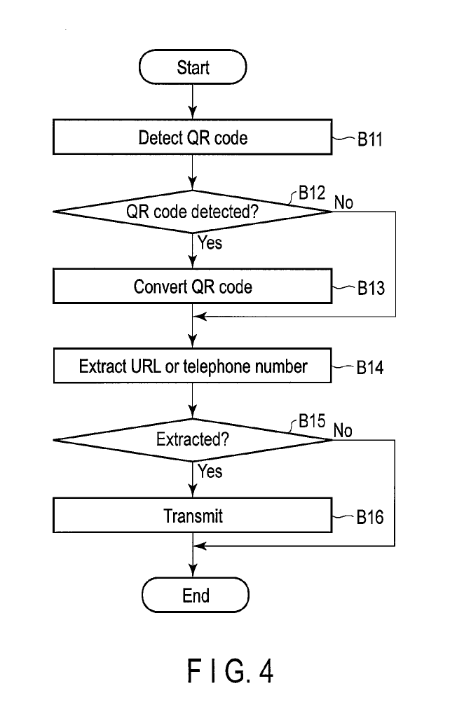

FIG. 4 is a flowchart showing an example of steps of extracting a URL or a telephone number and transmitting the extracted URL or telephone number to the remote controller 20.

First, the QR code detection module 402 attempts to detect an image including a QR code from the image data included in the PSI/SI data decoded by the PSI/SI decoder 105 (step B11). If an image including a QR code is detected, the QR code detection module 402 delivers the image including the QR code to the QR code conversion processing module 403. If an image including a QR code is not detected, the QR code detection module 402 notifies the QR code conversion processing module 403 that an image including a QR code cannot be detected. The QR code conversion processing module 403 determines whether a QR code is detected (step B12). If a QR code is detected (Yes in step B12), the QR code conversion processing module 403 converts the QR code into a character string (step B13). The QR code conversion processing module 403 delivers the character string to the extraction processing module 404. If a QR code is not detected (No in step B12), the QR code conversion processing module 403 notifies the extraction processing module 404 that no character string corresponds to a QR code.

The extraction processing module 404 attempts to extract a URL of a website or a telephone number from the character string delivered from the QR code conversion processing module 403 or/and the text data included in the PSI/SI data decoded by the PSI/SI decoder (step B14). If a URL or a telephone number is extracted, the extraction processing module 404 delivers the extracted URL or telephone number to the transmission processing module 405. If a URL or a telephone number is not extracted, the extraction processing module 404 notifies the transmission processing module 405 that a URL or a telephone number is not extracted.

The transmission processing module 405 determines whether a URL or a telephone number is extracted (step B15). If a URL or a telephone number is extracted (Yes in step B15), the transmission processing module 405 transmits the data for requesting setting of the extracted URL or telephone number in the NFC transmission device 203 to the remote controller 20 by using the TV Bluetooth device 113 (step B16).

The remote controller 20 receives the data transmitted from the transmission processing module 405 by the Bluetooth device. The Bluetooth device delivers the received data to the NFC device. The NFC device transmits the data to the smartphone 30 when the remote controller 20 touches the smartphone 30. The smartphone 30 which has received the data can access a site corresponding to the received data or call a telephone number corresponding to the received data.

If a broadcasting information descriptor for transmitting data to the NFC transmitting device is defined, the data broadcasting application 120 may transmit data for setting data appended to the broadcasting information descriptor in the NFC transmitting device.

Furthermore, the smartphone 30 may access a map site and display a map based on a location of a shop, a tourist spot, etc., introduced on the air by appending location information indicating the location of the shop, tourist spot, etc., introduced on the air, setting the location information in the NFC transmitting device 203 and receiving the location information transmitted from the NFC transmitting device 203 by the smartphone 30.

A specific application may accumulate points provided based on data by appending data for providing a user with points to a newly defined broadcasting information descriptor, setting the appended data to the NFC transmitting device 203 and receiving the data transmitted from the NFC transmitting device 203 by the smartphone 30 on which the specific application is running.

The NFC transmitting device 203 may be provided in the television 10. However, if the NFC transmitting device 203 is mounted on the remote controller 20 associated with the television 10, the user can operate the NFC transmitting device 203 at hand while viewing.

When an object is selected on a data broadcasting screen by an arrow key in the operation button group 201 while viewing, if a URL, a telephone number, etc., are embedded in the object, the URL, the telephone number, etc., may be reflected on the NFC transmitting device 203.

When a program recorded on the television 10 is watched by means of the smartphone 30 via a Digital Living Network Alliance (DLNA) network, the smartphone 30 can acquire a network path of the television 10 and the recorded data can be easily watched by setting the network path of the television 10 in the NFC transmitting device 203 and receiving the network path transmitted from the NFC transmitting device 203 by the smartphone 30.

An online manual can be read by means of the smartphone 30 by setting a URL storing the manual to the NFC transmitting device 203 and receiving the URL transmitted from the NFC transmitting device 203 by the smartphone 30.

When an instrument setup of the television 10 is executed via the network, the smartphone 30 can access a page for executing the instrument setup by setting an access path of the page for executing the instrument setup and receiving the network path transmitted from the NFC transmitting device 203.

The smartphone 30 may access a map site and display a map based on an address by extracting the address from the text data included in the data decoded by the PSI/SI decoder, setting the address in the NFC transmitting device 203 and receiving the address transmitted from the NFC transmitting device 203 by the smartphone 30.

As described above, according to the present embodiment, a TS packet is generated by demodulating a received broadcast wave, second information including information such as a URL (address) of a website, a telephone number, etc., which enables an external apparatus such as the smartphone 30 to access the website or to call the telephone number, is extracted from the data for displaying data broadcasting included in the PSI/SI data included in the TS packet, and data for setting the extracted second information in the NFC transmitting device 203 provided in the remote controller 20 is transmitted to the remote controller 20 by means of the TV Bluetooth device. In this way, the NFC receiving device 301 can receive the second information from the NFC transmitting device 203 by the NFC receiving device 301 of the smartphone 30 being brought near the NFC transmitting device 203 by a user such that the smartphone 30 can thereby easily access a place corresponding to the second information.

Since each of the steps of the present embodiment can be executed by a computer program, the same advantage as the present embodiment can be easily achieved by merely installing the computer program on a general computer through a computer-readable storage medium, which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a demodulator configured to generate first information by demodulating a tuned broadcast wave;
an extraction processor configured to extract second information for an external apparatus, the second information comprising access information to another electronic apparatus, based on the first information; and
a transmission processor configured to transmit data comprising the second information to a near-field communicator.

2. The apparatus of claim 1, further comprising a conversion module configured to convert an image, which is generated based on the first information and comprises information indicative of an address of a website, into third information,
wherein the extraction processor is configure to extract the address as the second information from the third information.

3. The apparatus of claim 1, further comprising a conversion module configured to convert an image, which is generated based on the first information and comprises information indicative of a telephone number, into third information,
wherein the extraction processor is configured to extract the telephone number as the second information from the third information.

4. The apparatus of claim 1, wherein the extraction processor is configured to extract an address of a website as the second information from text data generated based on the first information.

5. The apparatus of claim 1, wherein the extraction processor is configured to extract a telephone number as the second information from text data generated based on the first information.

6. A method of controlling an electronic apparatus, comprising:
extracting second information for an external apparatus, the second information comprising access information to another electronic apparatus based on first information generated by demodulating a tuned broadcast wave; and
transmitting data comprising the second information to a near-field communicator.

7. A computer readable, non transitory storage medium configured to store a computer program which is executable by a computer, the computer program controlling the computer to execute functions of:
extracting second information for an external apparatus, the second information comprising access information to another electronic apparatus based on first information generated by demodulating a tuned broadcast wave; and
transmitting data comprising the second information to a near-field communicator.
